(19) United States
(12) Patent Application Publication
(10) Pub. No.: US 2012/0163927 A1
(43) Pub. Date: Jun. 28, 2012

(54) SUCTION APPARATUS AND METHOD FOR EXTRACTING BULK MATERIAL FROM A CONTAINER

(75) Inventors: Torben KAMINSKY, Lemfoerde (DE); Maria Thomas, Muehlen (DE); Hartmut Giesker, Bissendorf (DE); Christoph Bahr, Lembruch (DE); Berndt Buder, Nordenham (DE); Günter Müntinga, Grossenkneten 7 (DE)

(73) Assignee: BASF SE, Ludwigshafen (DE)

(21) Appl. No.: 13/331,641

(22) Filed: Dec. 20, 2011

Related U.S. Application Data
(60) Provisional application No. 61/425,790, filed on Dec. 22, 2010.

(51) Int. Cl. B65G 53/40; B65G 53/24

(52) U.S. Cl. 406/135

(57) ABSTRACT

A method for extracting bulk material from a container which is open at the top by means of a suction apparatus which comprises at least one suction pipe (10) and one or more scrapers (12), with the suction apparatus being laid from above onto the surface of the bulk material in the container and bulk material being sucked away through the at least one suction pipe (10), wherein, during a repeated relative rotational movement between the scraper (12) and the surface of the bulk material in the container, bulk material is conveyed along the one or more scrapers (12) in the direction of the at least one suction pipe (10).

The present invention relates to a method for extracting bulk material from a container which is open at the top by means of a suction apparatus which comprises at least one suction pipe and one or more scrapers, with the suction apparatus being laid from above onto the surface of the bulk material in the container and bulk material being sucked away through the at least one suction pipe. The invention also relates to a suction apparatus for carrying out the method according to the invention, comprising at least one suction pipe and one more scrapers.

Nowadays, bulk materials are transported not only in silos, barrels or sacks, but rather increasingly also in large packages such as octabins or big bags, also referred to as FIBC (flexible intermediate bulk container). An octabin is conventionally composed of an octagonal cardboard carton which is provided with a plastic inliner, usually composed of polyethylene. Normal outer diameters of such packages range from 100 to 120 cm with a fill volume of 0.5 to 2 m³. A big bag or FIBC is a flexible transport container composed of a stable plastic fabric, for example a polypropylene fabric coated with polyethylene, the holding capacity of which normally ranges from 0.5 to 2 m³.

Such containers are used for transporting different bulk materials, from coarse-grain or fine-grain granulates, for example building materials such as sand, gravel, ballast, foodstuffs and seeds, via pellets to powder substances such as pigments. Different methods have become established for extracting a bulk material from such a container, inter alia suction by the application of a vacuum. Suction offers the advantage, in contrast to tipping out, that for example the generation of dust, which could possibly pose a health hazard, is avoided during the emptying process. However, suction is also associated with problems, in particular if the bulk material tends to clump together during transport or storage.

To be able to use suction for such bulk materials too, techniques have been developed for loosening up the bulk material. For example, the laid-open specification DE 28 00 853 A1 describes a method for unloading bulk materials from containers such as ships or hopper carriages. The suction apparatus has apparatuses for generating vibrations and also has outlets for compressed air. By means of vibration and blasts of compressed air, the bulk material surrounding the suction apparatus is loosened up before being sucked away.

More recently, methods and apparatuses have also been disclosed for emptying bulk material from flexible, in particular sack-like or bag-like containers. In document EP 1 199 266 A1, for this purpose, a suction apparatus which is of downwardly conical design is laid repeatedly onto the surface of the bulk material, said suction apparatus sinking partially into the bulk material under its own weight, and is subsequently pulled out of the bulk material again. As a result of the suction apparatus being repeatedly laid on and pulled out, the surface of the bulk material is loosened up, and crater walls which possibly form are caused to collapse. Here, the upper edge of the container is suspended on a lifting gear. During the emptying process, the container is pulled upward by the lifting gear in order to keep the wall of the container taut. It is mentioned that the tip of the suction apparatus may be provided with rotatable projections in order firstly to enlarge the effective radius of the suction apparatus and secondly to impart a mechanical scraping effect to loosen up the bulk material.

Document EP 1 580 133 B1 discloses a similar method for emptying flexible containers. Said method differs from the method mentioned above in that compressed air is used to loosen up the bulk material surface. Said compressed air is discharged intermittently, for example in blasts or in a pulsed fashion, through outlet openings in the suction apparatus into the surrounding bulk material.

The apparatus described in the PCT application WO 99/16691 A1 also uses compressed air to loosen up or fluidize a bulk material before it is sucked away. The suction apparatus is designed in terms of its dimensions so as to cover at least 50% of the cross-sectional area of the container from which the bulk material is to be sucked away.

However, as in the case of tipping out, the use of compressed air can lead to the generation of dust, which in most cases is undesirable. This problem is addressed in the German patent document DE 42 18 331 C2. To be able to extract the bulk material as uniformly as possible from a container, said document proposes as a suction apparatus a suction lance which is mounted so as to be movable in all three spatial directions. As a method, it is proposed that the suction lance be guided in defined paths over the bulk material surface, and that, in this way, the bulk material be sucked away layer by layer.

The known apparatuses and methods for extracting bulk material from a container are aimed predominantly at poorly flowing powders as bulk materials. Said apparatuses and methods are however unsuitable for a class of bulk materials which undergo intense block formation during transportation and storage. Examples of such bulk materials are granulates of elastomers such as thermoplastic polymers. In these cases, the known methods for loosening up and conveying the bulk material are inadequate.

The problem addressed is that of providing a method and an apparatus for extracting a bulk material which has a tendency to undergo intense block formation from a container in a simple manner. The apparatus should be of simple design and robust in operation.

Said problem is solved by means of the subject matter of the invention as detailed in claim 1. An apparatus according to the invention is specified in claim 8. Dependent claims 2 to 7 and 9 to 15 relate to further advantageous embodiments of the invention.

According to the invention, bulk material is extracted from a container which is open at the top by means of a suction apparatus which comprises at least one suction pipe and one or more scrapers, with the suction apparatus being laid from above onto the surface of the bulk material in the container and bulk material being sucked away through the at least one suction pipe, wherein, during a repeated relative rotational movement between the scraper and the surface of the bulk material in the container, bulk material is conveyed along the one or more scrapers in the direction of the at least one suction pipe. The suction pipe may have connected to it a feed line through which the bulk material which has been sucked away is conducted to a location for further processing. The feed line may be attached so as to be positionally fixed, for example as fixed pipework, though may also be of flexible design, for example in the form of a hose.

The invention can advantageously be applied to different types of containers. The invention is particularly suitable for containers of the above-described type, such as octabins or big bags. It is advantageous if the cross-sectional area of the container does not vary, or varies only little, along its vertical extent, such as is the case for example with free-standing containers such as octabins. To use the method with non-self-supporting containers with flexible walls such as big bags, for example, it is necessary to provide a suitable holding apparatus which ensures that the cross-sectional area of the container varies only insignificantly during the emptying process.

In a preferred embodiment of the invention which is suitable for the extraction of bulk material from a container with flexible walls, for example a big bag, the holding apparatus comprises a ring, preferably a square ring, which is attached in a height-adjustable manner to a linkage assembly. Lugs with securing hoops are situated in each case at at least four points of the ring, preferably the corners in the case of a square ring. Loops which are normally situated in each case on the upper edge of the container are hooked into said lugs. As a result of the height adjustment of the ring, which may be effected for example hydraulically, the container is pulled upward. In this embodiment, it can be ensured that the flexible wall of the container is tautly aligned at least in the region in which the suction apparatus is situated in each case during the extraction process, such that the cross-sectional area of the container barely changes in the vertical direction.

One option for quantitively evaluating the change in cross-sectional area consists in approximating the cross-sectional area by means of an inscribed circle at the inner wall of the container, and determining the difference between the greatest and the smallest inscribed circle over the vertical height of the container. Said difference is preferably at most 17 cm, particularly preferably at most 10 cm, in particular at most 6 cm.

The suction apparatus is preferably mounted in a guide which makes it possible for the suction apparatus to be introduced into the container in the vertical direction from above. What is preferable is a guide in which at least two mounting arrangements are arranged vertically one above the other, along which mounting arrangements the suction apparatus can be moved. Said embodiment has the advantage that the risk of tilting of the suction apparatus as it is inserted into the container is minimized. Fully areal mounting is preferably also realized, for example by means of pipes which are guided one inside the other and have round or angular cross-sections matched to one another.

The relative rotational movement may be generated by virtue of the suction apparatus being mounted so as not only to be movable in the vertical direction but also such that it can perform a rotational movement, for example driven by an electric motor. To prevent a connected feed line from also being rotated during a rotation of the suction apparatus, a rotary leadthrough must be provided, which is preferably of air-tight design. The rotary leadthrough may be provided between the feed line and the suction pipe. Alternatively, the rotary leadthrough may be integrated into the suction apparatus, for example by virtue of the suction pipe being mounted so as to be rotatable relative to the other components of the suction apparatus. In this embodiment, the container may be set up so as to be positionally fixed, for example on a base plate, a palette or in an enclosure which hinders or prevents a rotation of the container.

In a preferred embodiment, the suction apparatus is attached so as to be substantially positionally fixed in the horizontal direction, and the relative rotational movement is generated by virtue of the container being placed on a drive apparatus which imparts a rotational movement to the container. In this context, “substantially positionally fixed” is to be understood to mean that, as suction is carried out, the suction apparatus is mounted in the horizontal plane at one location and is not actively moved away from said location. Here, it should however not be ruled out that the suction apparatus also moves in the horizontal direction within narrow limits as a result of the action of force on account of the relative rotational movement. Furthermore, the suction apparatus may by all means also be attached so as to be movable in the horizontal direction, for example on a crane bridge, in order to be able to position the suction apparatus at different locations. During the suction process, however, it remains substantially positionally fixed. In this embodiment, it is also advantageous for the suction apparatus to also be secured against a rotational movement. In the case of mounting in two pipes which are vertically movable one inside the other and which have angular cross sections, for example, said securing action is generated already by the geometry. With corresponding mounting in pipes with a round cross section, a rotational movement of the suction apparatus can be prevented by means of known shaft-hub connections.

In an advantageous embodiment, the drive apparatus comprises a rotatably mounted plate which can be driven via a gearing by a motor, for example an electric motor. It is also advantageous for an enclosure for the placement of the container to be provided on the plate, which enclosure is designed firstly to ensure centering of the container beneath the suction apparatus and secondly to prevent a relative movement between the container and plate.

The mounting of the suction apparatus may be designed such that the suction apparatus can be pressed into the surface of the container under the expenditure of force. For example, the pressure force of the suction apparatus on the bulk material surface may be increased by means of pneumatic or hydraulic cylinders which may be installed for example laterally adjacent to the intake pipe. Here, a corresponding pressure of the gas or of the hydraulic fluid is transmitted to the bulk material surface. In one advantageous embodiment of the invention, the expenditure of force can be controlled during the suction process and adapted to the respective conditions. Such an embodiment may offer advantages during the suction of hard, brittle bulk materials which tend to undergo block formation, such as crystalline material or minerals.

In the case of many bulk materials, however, the own weight of the suction apparatus is already sufficient to cause the latter to at least partially sink into the surface of the bulk material in the container. Therefore, in a preferred embodiment, an active introduction of the suction apparatus into the container is dispensed with, such that the suction apparatus moves downward in the container during the suction process exclusively under its own weight. The own weight of the suction apparatus is particularly preferably adapted to the bulk material to be extracted, and selected such that the suction apparatus sinks into the surface of the bulk material up to a desired value. This adaptation may be realized for example by attaching additional weights to or onto the suction apparatus. An adaptation to different bulk materials can be realized in a simple manner for example by means of detachably mounted additional weights of different mass.

In a preferred embodiment of the method according to the invention, the uppermost layer of the bulk material is loosened up by the repeated relative rotational movement between the scraper and the surface of the bulk material in the container, before loosened-up bulk material is conveyed to the at least one suction pipe and sucked away. This process is one of mechanical loosening, based on components of the suction apparatus sinking at least partially into the surface of the bulk material, and forces possibly existing between the bulk material particles being overcome by the introduction of force on account of the relative movement. The distance between the individual bulk material particles is increased, and the block formation in the bulk material is broken up. The functions of loosening and conveying to the suction pipe are particularly advantageously performed by the one or more scrapers. Suitable designs of the scrapers will be specified below.

The method according to the invention can advantageously be applied to different types of bulk materials, for example glass, ceramic, metallic, polymer or mineral materials. The bulk materials may for example be solid, hollowed, porous, resilient, deformable, spongy, treated, ground or milled. The individual bulk material particles may be present in a wide variety of forms, for example as bladders, bubbles, powder, granulate, fibers, flakes, cuboids, spheres, ellipsoids or mixtures thereof.

The method is particularly suitable if the bulk material is an adherent, adhesive, sluggishly flowing and/or resilient material. In bulk material technology, a bulk material is referred to as being easily flowing or freely flowing if it can be caused to flow without expenditure, for example if it flows out of a container which is open at the bottom under the force of gravity. In contrast, in the case of a sluggishly flowing or poorly flowing bulk material, a force must be applied in order to enable or facilitate the flow. The ratio of consolidation stress to compressive stress is conventionally defined as a characteristic value for flowability. In the definitive work “Dietmar Schulze: Pulver and Schüttgüter [Powders and Bulk Materials]”, Springer-Verlag Berlin Heidelberg, 2006”, said characteristic value is used as a basis for classification into non-flowing, highly cohesive, cohesive, easily flowing and freely flowing. Within the context of this definition and terminology, the method according to the invention is particularly suitable for cohesive, highly cohesive and non-flowing bulk materials, in particular for non-flowing bulk materials.

The method according to the invention makes it possible even for bulk materials of this type to be extracted by suction from a container which is open at the top, where methods known from the prior art fail or have considerable disadvantages. Sluggishly flowing materials have the characteristic that, even in the loosened state, they do not flow or barely flow into a suction funnel which is formed. In the case of materials of this type, the areal conveyance of the bulk material at its surface to the suction point, effected by the relative rotational movement, is particularly advantageous. In the case of adherent or adhesive materials, not only is the conveyance to the suction point advantageous, but additionally the loosening of the bulk material surface by the scrapers. Some elastic materials tend to undergo block formation, and are sluggishly flowing. In the case of these elastic materials, the advantages of the method according to the invention are particularly pronounced. The method according to the invention is particularly advantageous for bulk materials in the form of a granulate or pellets composed of thermoplastic polymer, in particular of thermoplastic polyurethane.

In a preferred embodiment, the diameter of the circumscribed circle around the radially outer edge of the suction apparatus is smaller by 3 to 20 cm, preferably by 6 to 16 cm, in particular by 8 to 14 cm, than the diameter of the inscribed circle at the inner wall of the container from which the bulk material is extracted. Here, the inscribed circle is to be understood to mean the circle with the greatest possible diameter which can fit into the cross section through the container perpendicular to the axis of rotation. In the example of an octabin as a container, which has a symmetrical octagonal cross section, the inscribed circle makes contact tangentially with the edges of the cross section. The inscribed circle diameter corresponds in this case to the spacing between two opposite edges. The plastic inliner usually contained in an octabin can be disregarded for the calculation of the inscribed circle as long as its cross-sectional area is not smaller than that of the inscribed circle at the inner wall of the container. The circumscribed circle is to be understood to mean the circle with the smallest possible diameter which surrounds all the components of the suction apparatus in the radial direction. Here, the radial direction refers to the outward direction perpendicular to the axis of rotation. Examples for determining the circumscribed circle are specified in the explanation of the drawing.

In the case of a container whose cross-sectional area is non-constant in the vertical direction, the above preferred specified ranges relate to the difference between the circumscribed circle diameter and the in each case smallest and largest inscribed circle diameter. In the example of a container which tapers conically from top to bottom, the lower limits of the range are significant at the foot of the container and the upper limits of the range are significant at the upper opening of the container. It has been found that a selection of the diameter of the suction apparatus in the preferred ranges constitutes a good compromise with regard to the wall spacing between the suction apparatus and the inner wall of the container. In the case of a wall spacing which is too small, there is the risk of parts of the wall or of the plastic inliner in the case of an octabin coming into contact, for example, with elements of the suction apparatus, being destroyed on account of the relative rotational movement, and possibly contaminating the bulk material. In contrast, in the case of a wall spacing which is too large, it is possible in particular in the case of poorly flowing materials for a bulk material edge to form which does not collapse on its own, as a result of which the complete emptying of the container is impaired.

A suction apparatus suitable for carrying out the method according to the invention comprises at least one suction pipe and one or more scrapers, with the one or more scrapers being aligned substantially horizontally, and being of convex design in relation to a radial line from the axis of rotation to the outer end of the scraper as viewed in the relative movement direction of the bulk material. Examples of embodiments and arrangements according to the invention of scrapers and a suction pipe or suction pipes are specified in the description of the drawings. In an advantageous embodiment, the suction pipe or plurality of suction pipes are cylindrical pipe sections composed of metal, plastic or a composite material. The suction pipe or suction pipes is or are preferably produced from a metal, in particular a steel.

The scrapers are preferably designed as flat elongate elements whose extent in the radial direction is greater than their height in the vertical direction, and whose height is in turn greater than the material thickness. The height of the scrapers is preferably 1 to 20 cm, particularly preferably 2 to 10 cm. The scrapers are preferably produced from a metal, plastic or a composite material. The scrapers are particularly preferably produced from a metal, in particular a steel.

Also preferable are embodiments with three or four scrapers, which are arranged in each case symmetrically in the circumferential direction.

In an advantageous embodiment, the lower edge of the one or more scrapers is profiled, and designed in particular as a toothed profile. Here, the teeth may be of a known design, for example rectangular, square, trapezoidal or triangular, with sharp or rounded edges. Tooth tips hereinafter refer to those regions of the profile which form the lower edge. In the example of a triangular profile, the tooth tips may be punctiform. In the example of rectangular, square or trapezoidal profiles, the tooth tips are usually of plateau-like design. Tooth valleys hereinafter refer to those regions of the profile which are furthest remote from the tooth tips in the vertical direction. The connecting line between the tooth valleys and tooth tips forms the profile of the toothing.

The spacing between adjacent tooth tips is preferably 2 to 50 mm, particularly preferably 3 to 10 mm, wherein the spacing is to be understood to mean the extent of the intermediate space from the end of one tooth tip to the start of the adjacent tooth tip in the direction of the profile of the scraper lower edge. The recess between the teeth is preferably 2 to 15 mm, particularly preferably 3 to 10 mm. Here, the recess is to be understood to mean the vertical spacing between tooth tips and tooth valleys. Such a design of the scrapers promotes the loosening-up of the bulk material surface, and is particularly suitable for bulk materials composed of a hard material, for example crystalline, mineral or glass material.

In a preferred embodiment, the suction apparatus comprises a suction pipe which is arranged centrally in relation to the cross-sectional area of the suction apparatus, and also at least two scrapers which are arranged symmetrically in the circumferential direction. The cross section is defined in relation to the axis of rotation which, in this embodiment, preferably runs through the suction pipe.

In embodiments having a central suction pipe, the scrapers are advantageously defined such that, radially from the outside to the inside, their lower edges lie in the same plane or rise toward the suction pipe. The lower edges of the scrapers preferably rise from the outside to the inside, with the spacing between the lower edges at the inner ends and the plane running through the lower edges at the outer ends being 5 to 100%, particularly preferably 30 to 60% of the height of the scrapers at the outer ends.

The upper edges of the scrapers may lie in the same plane or may rise radially from the outside to the inside. In one embodiment, the lower edges rise in the inward direction, while the upper edges remain in the same plane. In this case, the height of the scrapers decreases from the outside to the inside. In another embodiment, the lower edges remain in the same plane, while the upper edges rise from the outside to the inside. In this case, the height of the scrapers increases from the outside to the inside. In a further embodiment, the profiles of the lower edges and upper edges are substantially identical from the outside to the inside, such that the height of the scrapers is substantially constant.

In a preferred embodiment, radially from the outside to the inside, the lower edges of the scrapers run horizontally over more than 50% of their length and rise toward the suction pipe, and the upper edges of the scrapers are higher at the suction pipe than at the radially outer end.

During a relative rotational movement between the scrapers and bulk material surface, on account of the convex design of the scrapers, the majority of the loosened-up bulk material is conveyed from the outside to the inside in the direction of the suction pipe. Here, an accumulation of bulk material in the form of a hill is generated in front of the central suction pipe. The preferred design of the scrapers, rising in the direction of the suction pipe, makes allowance for this fact and reduces the amount of bulk material which flows over the scrapers.

In a further preferred embodiment of suction apparatuses according to the invention, a support element is attached to the lower end of the suction pipe, which support element narrows downward in a punctiform manner but does not taper to a point, and forms the lowermost point of the suction apparatus. Said support element prevents the open end of the suction pipe from coming to rest on the container base when the bulk material has been almost completely sucked away. This prevents the suction pipe from adhering by suction to the container base or a plastic insert optionally provided in the container. The lower end, which is punctiform but does not taper to a point, of the support element likewise serves to protect the container base. In an advantageous embodiment of the invention, the support element is produced as a semi-circular or semi-elliptical torus, for example as a bent pipe with an outer pipe diameter of preferably 0.4 to 1.5 cm.

In a preferred embodiment, the scrapers are fastened, for example welded, with in each case one end directly to the suction pipe or to a sleeve which surrounds the suction pipe. The in each case other end of the scrapers projects radially away from the axis of rotation and downward. The outwardly projecting ends of the scrapers may be of self-supporting design or may be connected to an edge element. The ends are preferably connected to an edge element which forms the outer edge of the suction apparatus. The edge element is particularly advantageously designed as a circular ring.

In a further preferred embodiment, the suction apparatus has a supporting frame which comprises struts and an encircling edge element which is connected to the suction pipe via the struts. Here, the scrapers are fastened with in each case one end to the suction pipe or a strut and with the other end to the edge element or a strut. It is preferable for the edge element to be in the shape of a circular ring and to form the outer edge of the suction apparatus.

In a further preferred embodiment of a suction apparatus according to the invention, adjustable vanes are attached to the scrapers and/or to the edge element, by means of which vanes the contact pressure of the suction apparatus against the surface of the bulk material can be adjusted. Aside from the mentioned possibility of attaching additional weights to the suction apparatus in a detachable manner, the adjustable vanes are highly suitable for varying the contact pressure of the suction apparatus against the surface of the bulk material as required.

The vanes are preferably attached so as to be adjustable in the vertical direction, for example by means of a screw connection in slots on the edge element. The penetration depth of the scrapers and/or of the edge element into the bulk material surface can be influenced in this way. Furthermore, the vanes are preferably also attached so as to be adjustable in terms of their inclination in the rotational direction, for example likewise by means of a screw connection in slots on the edge element. A rising inclination of the vanes in the rotational direction causes the suction apparatus to be forced downward into the bulk material. Correspondingly, a falling inclination in the rotational direction causes the suction apparatus to be forced upward. The adjustability of the inclination constitutes a further degree of freedom for influencing the penetration depth.

The amount of bulk material that can be sucked away is determined substantially by the suction pressure prevailing in the suction pipe and by the ratio between air and loosened bulk material at the suction point. In the case of a high air/bulk material ratio, only a small amount of bulk material is sucked away, and the conveying rate is low. In the case of a low air/bulk material ratio, little air is present at the suction point and there is the risk of the suction pipe becoming blocked. Design parameters such as weight, shape and configuration of the components of the suction apparatus on the one hand and operating parameters such as suction pressure and rotational speed on the other hand are advantageously coordinated with one another. In this way, it is possible to realize as high a conveying rate as possible, while simultaneously minimizing the risk of blockages.

In a preferred embodiment of the suction apparatus according to the invention, the lower end of the suction pipe or of the suction pipes is attached so as to be adjustable relative to the lower edge of the scrapers. In a particularly advantageous embodiment, the suction pipe or suction pipes is/are surrounded by a sleeve in which they are fastened in a detachable manner and so as to be movable in the vertical direction, for example by means of a clamping connection or screw connection. The scrapers may in turn be detachably or non-detachably fastened to the sleeve or sleeves. By means of a suitable selection of the spacing between the lower edge of the scrapers and the lower end of the suction pipe or suction pipes, it is possible to adjust the air/bulk material ratio at the suction point to a desired value. The adjustability makes it possible for the suction apparatus to be adapted in a simple and fast manner to a different bulk material.

In a further preferred embodiment, the suction apparatus has a secondary air valve which is attached to the suction pipe. The secondary air valve is particularly preferably attached to the lower end of the suction pipe. Ambient air is sucked from the outside into the suction pipe through the secondary air valve. The secondary air valve is particularly preferably controllable, such that the amount of ambient air sucked in can be adjusted. In the case of a suction apparatus having a plurality of suction pipes, it is advantageous for a secondary air valve to be attached to each suction pipe. Secondary air valves and the adjustment thereof offer further degrees of freedom which permit an individual adaptation of the method according to the invention to respectively present conditions. By means of a suitable selection of the secondary air supply, it is possible for example to increase the rotational speed without increasing the probability of a blockage in the suction pipe.

In relation to methods known from the prior art for extracting bulk material from containers which are open at the top, the method according to the invention has considerable advantages. The bulk material is extracted in a uniformly distributed manner over the surface. On account of the conveyance by the relative rotational movement, it is possible for virtually the entire cross-sectional area of the container to be covered with only one suction pipe. The bulk material is loosened up gently, and the formation of dust and a health hazard possibly resulting therefrom are substantially avoided. The proposed apparatus according to the invention is simple in design and robust in operation.

The invention will be explained in more detail below on the basis of the drawings, wherein the drawings are to be understood to be diagrammatic illustrations. They do not constitute a restriction of the invention, for example with regard to physical dimensions or design variants. In the drawings:

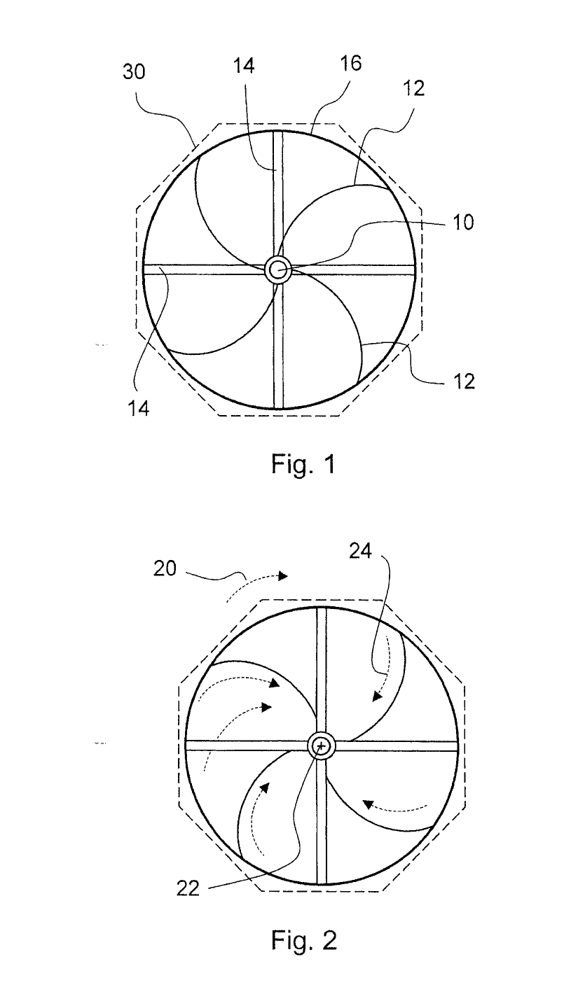

FIG. 1: shows a view from below of a suction apparatus according to the invention with supporting frame and four scrapers

FIG. 2: shows a view from above of the suction apparatus from FIG. 1, illustrating the rotational movement

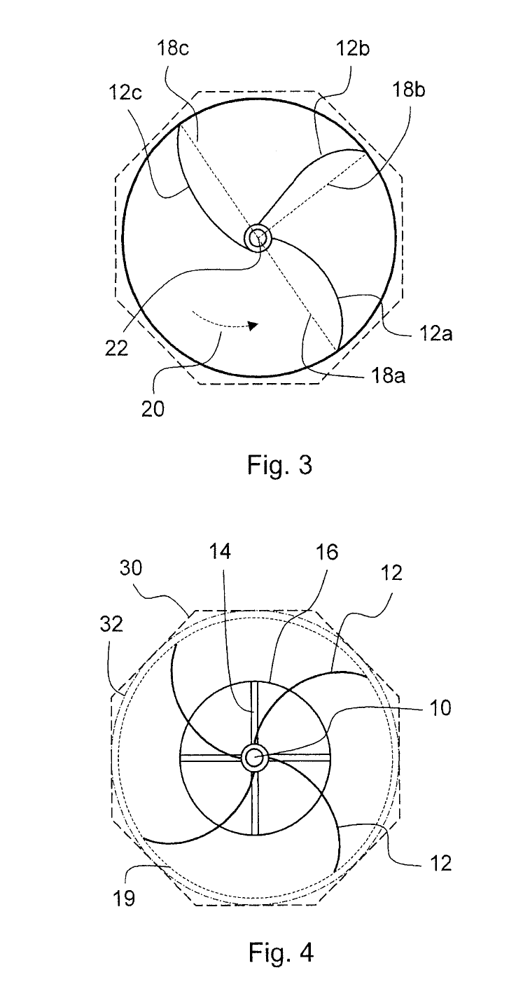

FIG. 3: shows exemplary designs of scrapers of a suction apparatus according to the invention

FIG. 4: shows a suction apparatus according to the invention with a supporting frame and scrapers which extend beyond the supporting frame

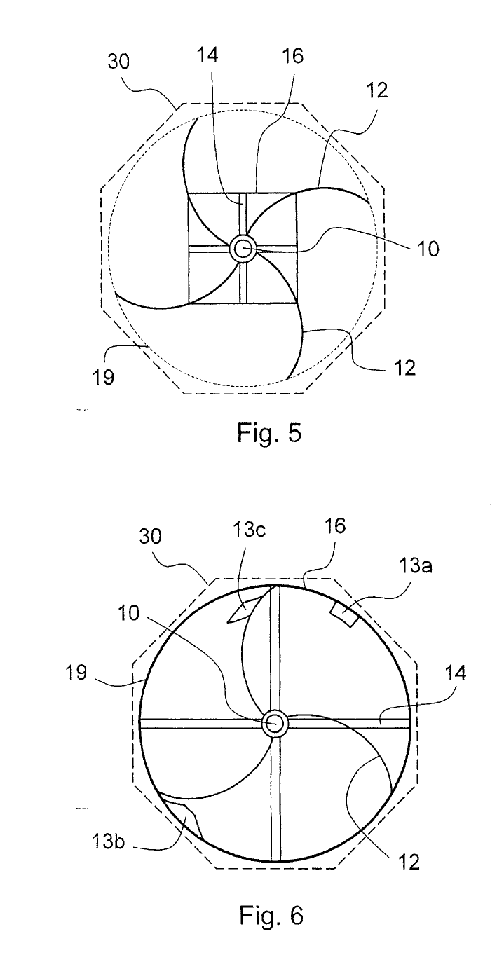

FIG. 5: shows a suction apparatus according to the invention with scrapers extending beyond the supporting frame and with a rectangular edge element of the supporting frame

FIG. 6: shows a suction apparatus according to the invention with a supporting rame and three scrapers

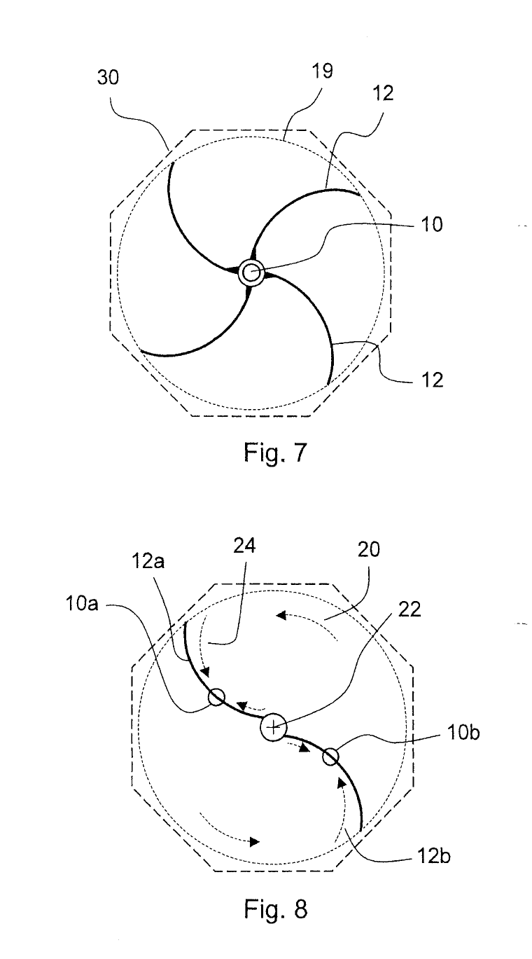

FIG. 7: shows a suction apparatus according to the invention without a supporting frame

FIG. 8: shows a suction apparatus according to the invention with two suction pipes without a supporting frame

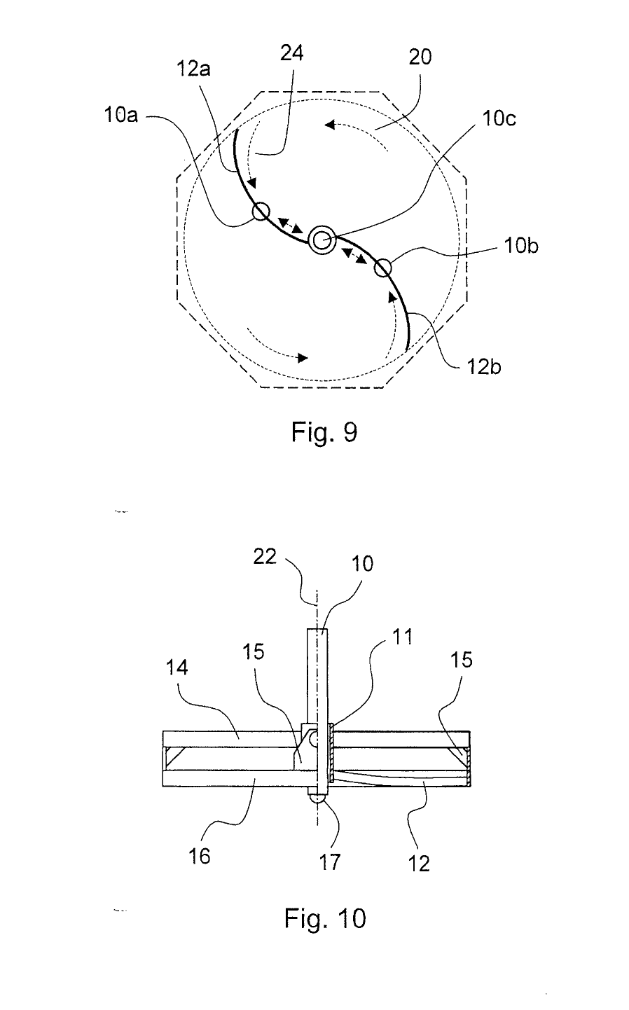

FIG. 9: shows a suction apparatus according to the invention with three suction pipes without a supporting frame

FIG. 10: shows a longitudinal section through a suction apparatus according to the invention with a supporting frame

FIG. 11: shows an exemplary embodiment in a three-dimensional view from above

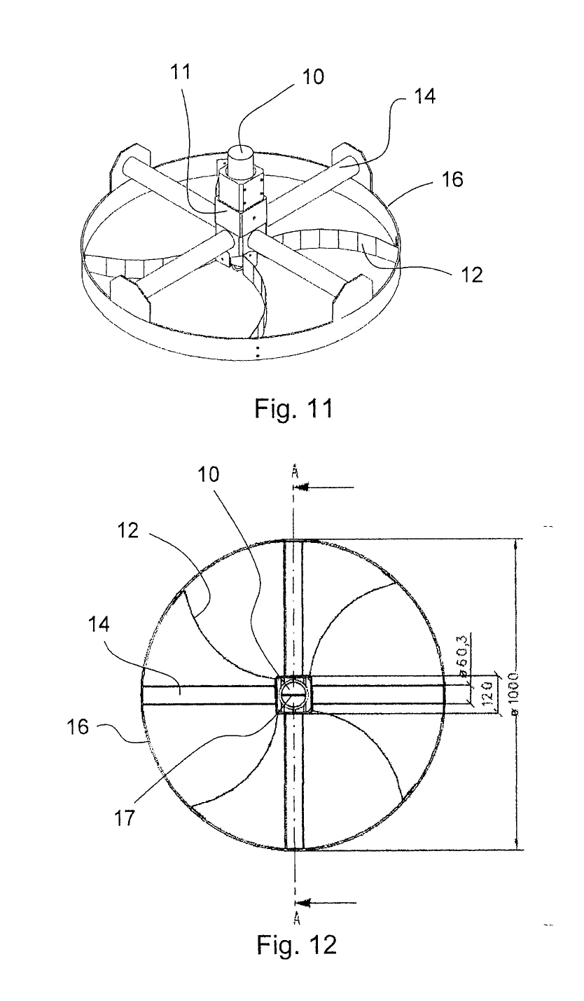

FIG. 12: shows an exemplary embodiment according to FIG. 11 in a two-dimensional plan view

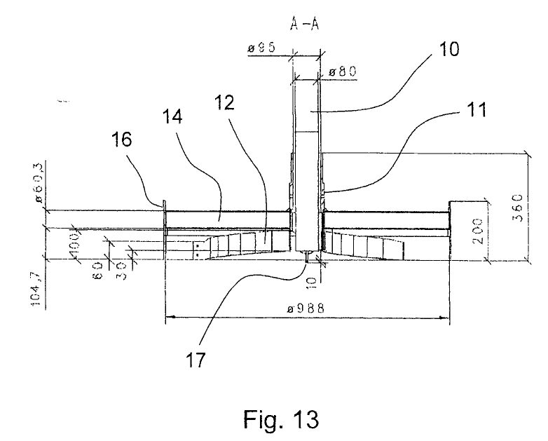

FIG. 13: shows an exemplary embodiment according to FIG. 11 in a two-dimensional longitudinal section

### LIST OF REFERENCE NUMERALS USED

10 . . . Suction pipe
11 . . . Sleeve
12 . . . Scraper
13 . . . Vane
14 . . . Strut
15 . . . Connecting element
16 . . . Edge element
17 . . . Supporting element
18 . . . Radial line from the axis of rotation to the outer end of a scraper
19 . . . Circumscribed circle around the outer edge of the suction apparatus
20 . . . Direction of the relative rotational movement
22 . . . Axis of rotation
24 . . . Conveying direction of the bulk material
30 . . . Container inner wall
32 . . . Inscribed circle at the container inner wall

FIG. 1 shows a suction apparatus according to the invention with a supporting frame, viewed from below. The supporting frame comprises four struts 14 and a circular-ring-shaped edge element 16 which, in the horizontal direction, forms the lower edge of the suction apparatus. The struts 14 are fastened to a centrally arranged suction pipe 10. Below the struts 14 in the vertical direction, four scrapers 12 are fastened with in each case one end to the suction pipe 12 and with the in each case other end to the edge element 16. An octabin serves, in FIG. 1 and in the subsequent figures, as an example for a container from which bulk material is to be extracted by means of the suction apparatus according to the invention. The octagonal cross section of the inner wall 30 of said octabin is illustrated by dashed lines.

FIG. 2 shows the suction apparatus from FIG. 1 in a view from above, that is to say looking into the container which is open at the top. The figure illustrates the situation in which the suction apparatus is positionally fixed with regard to its rotational movement, and the container rotates about an axis of rotation 22. The rotational direction of the container is indicated by the arrow 20. In this example, the bulk material in the container is rotated clockwise with the container. The suction apparatus rests on the surface of the bulk material. As a result of the own weight of the suction apparatus, the scrapers 12 project at least partially into the bulk material surface and form a positionally fixed resistance for the rotating bulk material. On account of the shaping of the scrapers 12, as can be clearly seen from FIG. 1 and FIG. 2, the bulk material at the surface is conveyed in the direction of the center of the suction apparatus, where the suction pipe 10 is situated. This conveyance is indicated in FIG. 2 by the arrows 24. A similar conveying action would be obtained if the container were positionally fixed and the suction apparatus were rotated counterclockwise about the axis of rotation 22.

Different embodiments of the scrapers 12a to 12c of suction apparatuses according to the invention will be explained by way of example below on the basis of FIG. 3. FIG. 3 illustrates, like FIG. 1, a view of the suction apparatus from below. The direction of the relative rotational movement 20 is accordingly reversed in relation to FIG. 2. For reasons of clarity, struts which connect the suction pipe to the edge element are not illustrated. According to the invention, the scrapers are of convex design, in relation to a radial line 18a, 18b, 18c from the axis of rotation 22 to the outer end of the scrapers 12a, 12b, 12c, in the direction of the relative movement of the bulk material.

The scraper 12a is shaped and arranged such that an imaginary elongation of the curvature in the direction of the suction pipe would intersect the axis of rotation. In this respect, the scraper 12a is arranged centrally. The radial line 18a is drawn from the axis of rotation to the end of the scraper 12a. In relation to said line 18a, the shape of the scraper 12a in horizontal cross section is convex, as can be clearly seen from FIG. 3.

In contrast to the scraper 12a, the scraper 12b is arranged slightly eccentrically. An imaginary elongation of the scraper 12b in the direction of the suction pipe would pass by the axis of rotation 22. Proceeding from the suction pipe, the scraper 12b is initially of straight design, before a convex curvature in relation to the line 18b follows after approximately half of the radial extent of said scraper 12b.

The scraper 12c has a less pronounced curvature than the scraper 12a. The scraper 12c is arranged even more eccentrically than the scraper 12b. This design is also convex in relation to the radial line 18c from the axis of rotation 22 to the outer end of the scraper 12c.

FIG. 4 shows a further suction apparatus according to the invention with a supporting frame, viewed from below. The supporting frame comprises four struts 14 which are fastened at in each case one end to a centrally arranged suction pipe 10. A circular-ring-shaped edge element 16 is connected to each of the in each case other ends of the struts 14. Below the struts 14 in the vertical direction, four scrapers 12 are fastened with in each case one end to the suction pipe 10 and with the in each case other end to the edge element 16. In contrast to the embodiment according to FIG. 1, however, the edge element 16 does not form the outer edge of the suction apparatus. The scrapers 12 project in the radial direction beyond the edge element 16. In this embodiment, the outer edge of the suction apparatus is formed by the respective ends of the four scrapers 12. In order that the container and suction apparatus can be rotated relative to one another, the radial extent of the scrapers 12 is selected such that the circumscribed circle 19 around the outer edge of the suction apparatus is of smaller diameter than the inscribed circle 32 at the container inner wall 30.

FIG. 5 illustrates a further suction apparatus according to the invention with a supporting frame. In contrast to the embodiment according to FIG. 4, the edge element 16 of the supporting frame is in this case not in the shape of a circular ring but rather is rectangular, in the physical example square.

FIG. 6 shows a suction apparatus according to the invention with a supporting frame, which suction apparatus, in contrast to the variants according to FIGS. 1, 2, 4 and 5, is provided with three scrapers 12. As in the preceding examples, the three scrapers are arranged symmetrically in the circumferential direction. In this example, the scrapers 12 do not project beyond the edge element 16 of the supporting frame, such that the outer edge of the circular-ring-shaped edge element 16 simultaneously forms the circumscribed circle 19 around the outer edge of the suction apparatus.

Furthermore, FIG. 6 also shows by way of example three design variants of adjustable vanes 13. The vane 13a is fastened to the edge element 16 so as to be adjustable, preferably both in the vertical direction and also with regard to the inclination in the rotational direction. The vane 13b is likewise fastened to the edge element 16, but a short distance behind a scraper 12 as viewed in the rotational direction. Finally, the vane 13c represents a variant in which the vane is fastened to a scraper 12. In this case, too, the vane 13c is preferably adjustable in the vertical direction.

A further embodiment of a suction apparatus according to the invention is shown in FIG. 7. The suction apparatus comprises a centrally arranged suction pipe 10 and four scrapers 12. The scrapers 12 are fastened, for example welded, directly to the suction pipe 10. This embodiment makes do without a supporting frame. As in the embodiments according to FIG. 4 and FIG. 5, the respective ends of the scrapers 12 form the outer edge of the suction apparatus. The radial extent of the scrapers 12 is selected such that the circumscribed circle 19 around the outer edge of the suction apparatus is of smaller diameter than the inscribed circle at the container inner wall 30.

FIG. 8 illustrates a suction apparatus according to the invention which has two suction pipes 10a, 10b and also two scrapers 12a, 12b. Provided in the center of the suction apparatus, through which the axis of rotation 22 runs, is a bracket to which in each case one end of a scraper is fastened. As viewed in the circumferential direction, the scrapers are arranged symmetrically. In the example illustrated, the suction apparatus is formed without a supporting frame. In the event of a relative rotational movement in the illustrated direction 20, bulk material is conveyed inward from the radially outer region, as indicated in FIG. 8 by the arrows 24. In the center of the bulk material surface in the vicinity of the axis of rotation 22, on account of the curvature of the scrapers 12a, 12b, bulk material is conveyed outward from the inside. The two suction pipes 10a, 10b are attached to the scrapers 12a, 12b at the point at which the bulk material conveyed inward from the outside and the bulk material conveyed outward from the inside converge.

In the embodiments with a central suction pipe 10, the convex shaping of the scrapers 12 likewise results in a flow behavior of the bulk material as depicted in FIG. 8. Overall, however, the conveyance from the outside to the inside is more pronounced than that from the inside to the outside, such that overall, it is ensured that the bulk material is conveyed along the scrapers 12 to the suction pipe 10. Here, however, a hill of loose bulk material builds up in the vertical direction in the vicinity of the central suction pipe 10. This effect is avoided in the embodiment with two suction pipes 10a, 10b according to FIG. 8.

FIG. 9 shows a suction apparatus according to the invention with three suction pipes 10a, 10b, 10c. Two of the suction pipes (10a, 10b) are attached to the scrapers 12a, 12b, as in the apparatus according to FIG. 8. A further suction pipe 10c is attached centrally in the middle of the suction apparatus, as in the preceding embodiments. In relation to the apparatus according to FIG. 8, the scrapers 12a, 12b are fastened to the central suction pipe further rearward in the rotational direction. This promotes a conveyance of the bulk material both radially outward in the direction of the suction pipes 10a, 10b and also a conveyance of a part of the bulk material in the direction of the central suction pipe 10c. Although this embodiment is of more complex design, it permits a considerably higher flow rate of sucked-away bulk material than the variants with fewer suction pipes.

FIG. 10 shows design details of a suction apparatus according to the invention with a supporting frame, such as is shown for example in FIGS. 1, 2 and 6. The illustration shows the view perpendicular to the axis of rotation 22, in the left-hand half of the figure as a view, and in the right-hand half as a longitudinal section along a plane through the axis of rotation 22. The suction pipe 10 is arranged centrally around the axis of rotation 22. Attached to the lower end of said suction pipe 10 is a support element 17 which is designed such that the suction apparatus touches down on the base of the container at the end of the emptying process in as punctiform a manner as possible, but which however does not taper to a point, in order to prevent damage to the container base. In the example, the support element 17 is designed as a semi-circular torus. In FIGS. 1 to 8, an optionally provided support element has not been illustrated for reasons of clarity.

Above the support element 17, the suction pipe 10 is surrounded by a sleeve 11 to which it is fixedly connected. In each case one end of the struts 14 is fastened to said sleeve 11, and the other end points radially outward. In the example, the struts 14 are designed as pipes. Fastened to the radially outer end of the struts 14 is in each case one connecting element 15 which projects downward beyond the struts 14. The lower end of said connecting elements 15 serves for fastening the edge element 16 of the supporting frame. Finally, the scrapers 12 are fastened with one end to the outer side of the sleeve 11, and with the other end to the inner side of the edge element 16. The sleeve 11 which is illustrated in this example is not imperatively necessary; the struts 14 and also the scrapers 12 may also be attached directly to the suction pipe.

In the embodiment illustrated, the scrapers 12 are shaped such that, in the radial direction from the outside inward, their upper and lower edges run initially horizontally and rise toward the suction pipe. This design makes allowance for the fact, described above, that a hill of loose bulk material forms in the vicinity of the central suction pipe 10 during the conveyance of the bulk material along the scrapers 12. As a result of the illustrated design, the amount of bulk material which flows over the scrapers 12 is considerably reduced.

### EXAMPLE

FIGS. 11 to 13 illustrate a physical example of a suction apparatus according to the invention. The specified dimensions in the drawings are in the units of millimeters.

FIG. 11 shows a three-dimensional view of the suction apparatus from above. The suction apparatus has a central suction pipe 10 which is fastened in a sleeve 11. The outer cross-sectional shape of the sleeve 11 is square. Attached to the sleeve 11 are four tubular struts 14 which run radially outward. Fastened to the outer ends of the struts 14 is an edge element 16 which is of circular shape in cross section. The suction apparatus also comprises four scrapers 12 which are fastened with in each case one end to the sleeve 11. The in each case other end of the scrapers 12 bears against the inner wall of the edge element 16 and is connected thereto by means of screws. The scrapers 12 are angled into sections.

FIG. 12 illustrates the suction apparatus in a two-dimensional plan view. The circumscribed circle around the outer edge of the suction apparatus corresponds to the outer edge of the edge element 16. The outer diameter thereof is 1000 mm. The sleeve 11 has an outer diameter of 120 mm, and the outer diameter of the struts 14 is 60.3 mm.

FIG. 13 illustrates a longitudinal section through the suction apparatus along the plane A-A in FIG. 12. The scrapers 12 are designed such that their lower edges rise from the outside to the inside. At the outer end, their lower edges are at the same level as the lower edge of the edge element 16. At the sleeve 11, the lower edges of the scrapers 12 are situated 30 mm higher. The height of the scrapers 12 is 60 mm at the edge element and, over the profile from the outside to the inside, rises to a value of 70 mm at the sleeve 11. The struts run horizontally proceeding from the sleeve 11 to the edge element 16. The underside thereof is situated 104.7 mm above the lower edge of the edge element 16. The height of the edge element 16 is 80 mm. The height of the struts 14 is 200 mm only at the points at which said struts are fastened to the edge element 16.

Attached to the lower end of the suction pipe 10 is a semi-circular torus as a supporting element 17. The lowermost point of the supporting element 17 is situated 10 mm below the lower edge of the edge element 16. This firstly prevents the suction pipe from being able to adhere by suction to the base of the container, and secondly reduces the probability of the edge element 16 touching down on the base of the container and possibly damaging the latter.

The suction apparatus has been fastened to a height-adjustable pipe of square cross section. The connection to a suction line of round cross section has been provided within said pipe. All the parts of the suction apparatus which come into contact during normal operation with the bulk material to be sucked away have been produced from high-grade steel. Powder-coated normal steel has been selected as a material for all the other parts.

By way of example, one ton of a granulate of thermoplastic polyurethane has been sucked out of an octabin by means of the suction apparatus according to the invention. Within the context of the abovementioned characteristic value for flowability (ratio of consolidation stress to compressive stress), the material is classified as “non-flowing”.

The full octabin on a palette was positioned, by means of a forklift truck, on a rotary plate. The rotary plate was situated below the suction apparatus. The octabin was centered on the rotary plate beneath the suction apparatus by means of guide elements. The suction apparatus was laid onto the granulate surface of the open octabin. A rotation of the rotary plate with a rotational speed of 5 revolutions per minute caused the granulate to be loosened up and conveyed to the central suction pipe. The suction took place with a flow rate of approximately one ton per hour.

During the course of the suction process, the surface of the bulk material in the octabin, and with it the suction apparatus, moved downward in the direction of the base of the container. When the suction apparatus touched down on the base of the container and the remaining granulate was sucked away, the suction process ended. The conveyance by suction and the rotation of the rotary plate were deactivated, the suction apparatus was pulled upward out of the octabin, and the empty container was removed.

By means of the suction apparatus according to the invention, it was possible in a simple manner to extract from a container a granulate of a non-flowing bulk material, for which conventional methods known from the prior art cannot be used.

1. A method for extracting bulk material from a container which is open at the top by means of a suction apparatus which comprises at least one suction pipe (10) and one or more scrapers (12), with the suction apparatus being laid from above onto the surface of the bulk material in the container and bulk material being sucked away through the at least one suction pipe (10), and with bulk material being conveyed along the one or more scrapers (12) in the direction of the at least one suction pipe (10) during a repeated relative rotational movement between the scraper (12) and the surface of the bulk material in the container, wherein the suction apparatus is attached so as to be substantially positionally fixed in the horizontal direction, and the relative rotational movement is generated by virtue of the container being placed on a drive apparatus which imparts a rotational movement to the container.

2. The method according to claim 1, with the diameter of the circumscribed circle (19) around the radially outer edge of the suction apparatus being smaller by 3 to 20 cm, preferably by 6 to 16 cm, in particular by 8 to 14 cm, than the diameter of the inscribed circle (32) at the inner wall of the container from which the bulk material is extracted.

3. The method according to claim 1 or 2, with the suction apparatus moving downward in the container during the suction process exclusively under its own weight.

4. The method according to at least one of claims 1 to 3, with the uppermost layer of the bulk material being loosened up by the repeated relative rotational movement between the scraper (12) and surface of the bulk material, before loosened-up bulk material is conveyed to the at least one suction pipe (10) and sucked away.

5. The method according to claim 4, with the bulk material being an adherent, adhesive, sluggishly flowing and/or resilient material.

6. The method according to at least one of claims 1 to 5, with the bulk material being a granulate or pellets composed of thermoplastic polymer, in particular thermoplastic polyurethane.

7. A suction apparatus for carrying out the method according to at least one of claims 1 to 6, comprising at least one suction pipe (10) and one or more scrapers (12), wherein the one or more scrapers (12) are aligned substantially horizontally, and are of convex design in relation to a radial line from the axis of rotation to the outer end of the scraper (12) as viewed in the relative movement direction of the bulk material, and the suction apparatus being mounted in a guide in which at least two mounting arrangements are arranged vertically one above the other, along which mounting arrangements the suction apparatus can be moved vertically, and with the suction apparatus being secured against a rotational movement.

8. The suction apparatus according to claim 7, with a suction pipe (10) being arranged centrally in relation to the cross-sectional area of the suction apparatus, with at least two scrapers (12) being provided, and with the at least two scrapers (12) being arranged symmetrically in the circumferential direction.

9. The suction apparatus according to claim 8, wherein radially from the outside to the inside, the lower edges of the scrapers (12) run horizontally over more than 50% of their length and rise toward the suction pipe (10), and the upper edges of the scrapers (12) are higher at the suction pipe than at the radially outer end.

10. The suction apparatus according to claim 8 or 9, with a support element (17) being attached to the lower end of the suction pipe (10), which support element narrows downward in a punctiform manner but does not taper to a point, and forms the lowermost point of the suction apparatus.

11. The suction apparatus according to at least one of claims 8 to 10, which furthermore has a supporting frame which comprises struts (14) and an encircling edge element (16) which is connected to the suction pipe (10) via the struts (14), and with the scrapers (12) being fastened with in each case one end to the suction pipe (10) or a strut (14) and with the other end to the edge element (16) or a strut (14).

12. The suction apparatus according to claim 11, with the edge element (16) being in the shape of a circular ring and forming the outer edge of the suction apparatus.

13. The suction apparatus according to at least one of claims 7 to 12, with adjustable vanes (13) being attached to the scrapers (12) and/or to the edge element (16), by means of which vanes (13) the contact pressure of the suction apparatus against the surface of the bulk material can be adjusted.

14. The suction apparatus according to at least one of claims 7 to 13, with the lower edge of the one or more scrapers (12) being designed as a toothed profile.

15. The suction apparatus according to at least one of claims 7 to 14, with the diameter of the circumscribed circle (19) around the radially outer edge of the suction apparatus being smaller by 3 to 20 cm, preferably by 6 to 16 cm, in particular by 8 to 14 cm, than the diameter of the inscribed circle (32) at the inner wall of the container from which the bulk material can be extracted by means of the suction apparatus.
